(19) United States
(12) Patent Application Publication
(10) Pub. No.: US 2006/0231474 A1
(43) Pub. Date: Oct. 19, 2006

(54) Fluid-magnetizing device

(76) Inventor: Jen-Pen Chang, Wuri Shiang (TW)

Correspondence Address: TROXELL LAW OFFICE PLLC, SUITE 1404, 5205 LEESBURG PIKE, FALLS CHURCH, VA, 22041, US

(21) Appl. No.: 11/402,053

(22) Filed: Apr. 12, 2006

(30) Foreign Application Priority Data
Apr. 13, 2005 (TW) 094205782

(51) Int. Cl. C02F 1/48

(52) U.S. Cl. 210/222; 210/223; 210/512.1

(57) ABSTRACT

A fluid-magnetizing device including an arced magnetic collar on which multiple outer casings are disposed. The outer casings are made from magnetic shield material. Multiple magnetic elements are accommodated in the outer casings of the magnetic collar. The magnetic collar has two ends between which multiple resilient members are connected for conveniently and firmly locating the magnetic collar around a fluid pipeline. At least one spiral flow guiding plate is disposed inside the fluid pipeline for guiding the fluid to spirally flow through the fluid pipeline. Accordingly, the contact time between the fluid and the magnetic lines is prolonged. In addition, the multiple magnetic elements are separately arranged to enhance and extend the magnetic lines so as to more efficiently magnetize the fluid in the fluid pipeline.

### BACKGROUND OF THE INVENTION

The present invention is related to an improved fluid-magnetizing device including multiple separately arranged magnetic elements for providing dense magnetic lines. In addition, the fluid-magnetizing device is able to make a fluid spirally flow through a fluid pipeline under the action of the dense magnetic lines so that the fluid can be more efficiently magnetized.

The magnetic lines of a magnetic body (magnet) are able to magnetize a fluid such as water to stabilize the molecules of the water. The stabilized water serves to strengthen human cells/tissues and enhance metabolism. This theory has been gradually realized and accepted by peoples. Various products for magnetizing fluids have been developed. It is known that the shortest path of the magnetic lines is between the two different magnetic poles. Also, the magnetic lines will not intersect each other. In addition, the farther the magnetic lines are away from the magnetic poles, the thinner the magnetic lines are (the weaker the magnetism is). Therefore, in the case that the magnetic bodies are simply disposed on two sides of a fluid passage, the magnetizing effect is limited. Moreover, conventionally, the magnetic bodies are simply adhered to or tied on two sides of the fluid passage. Under such circumstance, the magnetic bodies are easy to loosen or detach from the fluid passage.

Taiwanese Patent Publication No. 303882 (Application No. 85202435) discloses a water-magnetizing device. In this device, multiple magnetic rings are fixedly disposed around an inner water duct along an axis thereof. Each magnetic ring is composed of two semicircular magnets symmetrical to each other about a central line. The symmetrical portions of the magnets of the adjacent magnetic rings have the same polarity. Therefore, the magnetic lines are normal to the direction of the water flow to enhance the magnetizing effect. However, the shortest path of the magnetic lines extends between the two different magnetic poles. Therefore, in the case that the circular magnets are respectively arranged on two sides of the water passage, the magnetic lines of the magnets are not fully utilized to achieve highest magnetization efficiency. The water is magnetized only by means of strengthening the magnetism of the magnets and increasing the number of the magnets. Therefore, the manufacturing cost for such device is relatively high. This fails to meet the requirement of economy.

### SUMMARY OF THE INVENTION

It is therefore a primary object of the present invention to provide an improved fluid-magnetizing device including an arced magnetic collar and multiple magnetic elements disposed on the magnetic collar. The magnetic collar is located around a fluid pipeline. At least one spiral flow guiding plate is disposed inside the fluid pipeline for guiding the fluid to spirally flow through the fluid pipeline. Accordingly, the contact time between the fluid and the magnetic lines is prolonged. In addition, the multiple magnetic elements are separately arranged to enhance and extend the magnetic lines so as to more efficiently magnetize the fluid in the fluid pipeline.

It is a further object of the present invention to provide the above fluid-magnetizing device in which the magnetic elements are first fitted in inner casings without magnetic conductivity. Then the inner casings with the magnetic elements are accommodated in the outer casings made from magnetic shield materials. The outer casings are disposed on the circumference of the magnetic collar. The magnetic collar has two ends between which several resilient members are connected for conveniently and firmly locating the magnetic collar around the fluid pipeline;

The present invention can be best understood through the following description and accompanying drawings wherein:

### BRIEF DESCRIPTION OF THE DRAWINGS

FIG. 1 is a perspective exploded view of a first embodiment of the present invention;

FIG. 2 is a sectional assembled view of the first embodiment of the present invention;

FIG. 3 is a perspective assembled view of the first embodiment of the present invention;

FIG. 4 is a perspective exploded view of a second embodiment of the present invention;

FIG. 5 is a perspective exploded view of a third embodiment of the present invention;

FIG. 6 is a sectional assembled view of the third embodiment of the present invention;

FIG. 7 is a perspective assembled view of the third embodiment of the present invention;

FIG. 8 is a perspective exploded view of a fourth embodiment of the present invention;

FIG. 9 is a sectional assembled view of the fourth embodiment of the present invention; and

FIG. 10 is a perspective assembled view of the fourth embodiment of the present invention.

### DETAILED DESCRIPTION OF THE PREFERRED EMBODIMENTS

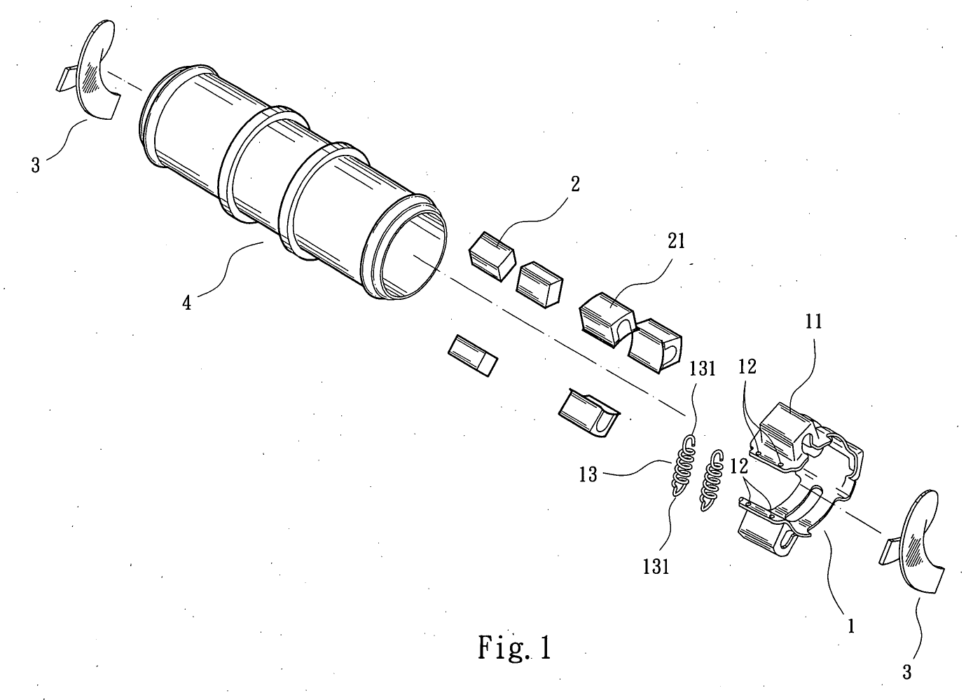

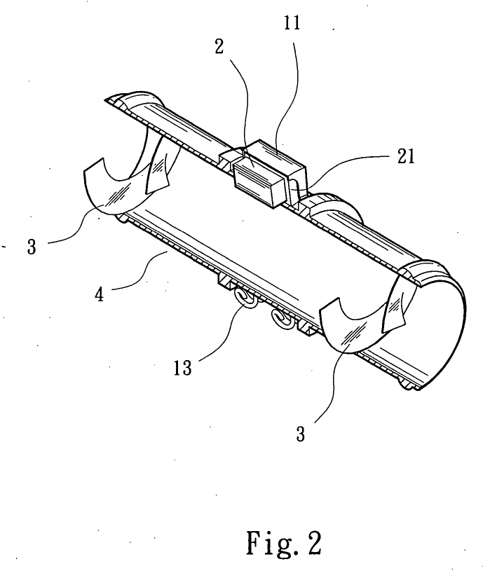

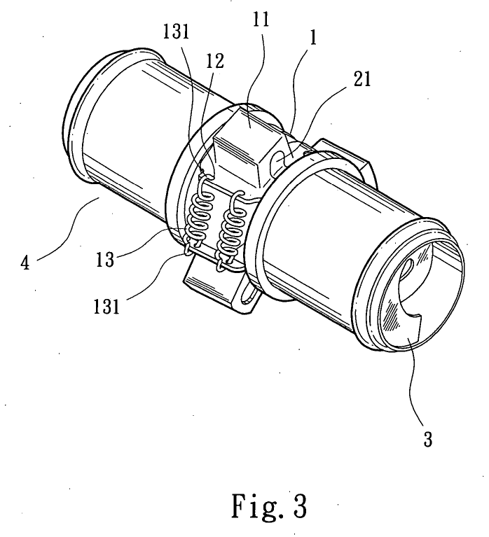

Please refer to FIGS. 1 to 3. The fluid-magnetizing device of the present invention includes a magnetic collar 1, several magnetic elements 2 and spiral flow-guiding plates 3. The magnetic collar 1 is an arced body made from magnetic conductive materials. Each end of the magnetic collar 1 is formed with at least one hole 12. Multiple outer casings 11 are disposed on a middle section of the magnetic collar 1. The magnetic elements 2 are individual magnetic bodies capable of producing magnetic lines (such as magnets). Each magnetic element 2 is fitted in an inner casing 21 without magnetic conductivity. Then the inner casing 21 with the magnetic element 2 is accommodated in the outer casing 11. The inner casing 21 serves to fasten and firmly locate the magnetic element 2 in the outer casing 11. The hook sections 131 of two ends of at least one resilient member 13 (spring) are respectively hooked between the holes 12 of the two ends of the magnetic collar 1. Therefore, the two ends of the magnetic collar 1 are resiliently movable relative to each other. A fluid pipeline 4 with a certain diameter can be fitted through the magnetic collar 1. In addition, other non-resilient fixing members (such as threaded rods) can be fixedly connected between the two holes 12 in addition to or instead of the springs so as to conveniently and firmly fit and locate the magnetic collar 1 on the fluid pipeline 4 in a predetermined position. The spiral flow guiding plates 3 are disposed inside the fluid pipeline 4 for guiding the fluid to spirally flow within the fluid pipeline 4. Multiple magnetic elements 2 are separately arranged to enhance and extend the magnetic lines. The contact time between the fluid and the magnetic lines is prolonged to more efficiently magnetize the fluid in the fluid pipeline.

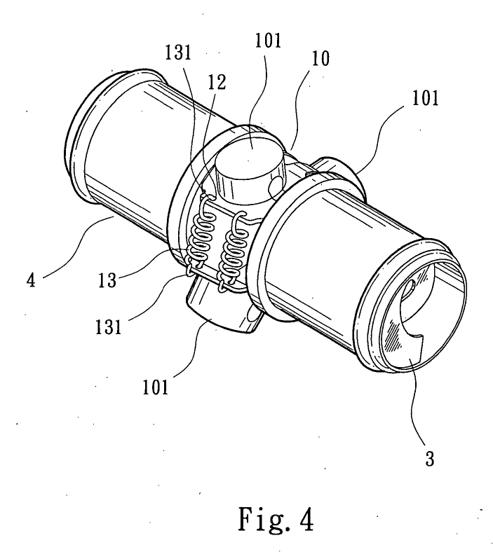

FIG. 4 shows a second embodiment of the present invention, in which the magnetic collar 10 is different from the magnetic collar 1 of the first embodiment only in that the magnetic collar 10 has cylindrical outer casings 101, while the magnetic collar 1 has rectangular solid outer casings 11. The magnetic elements received in the outer casings have the same configuration as the outer casings. The other parts of the second embodiment are identical to those of the first embodiment and will not be further described hereinafter.

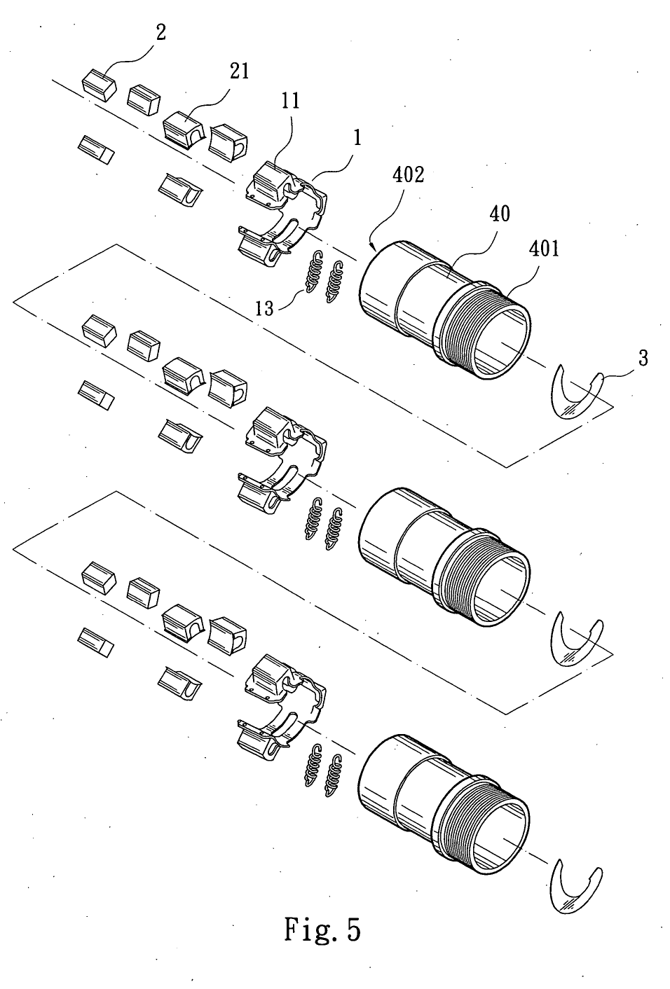

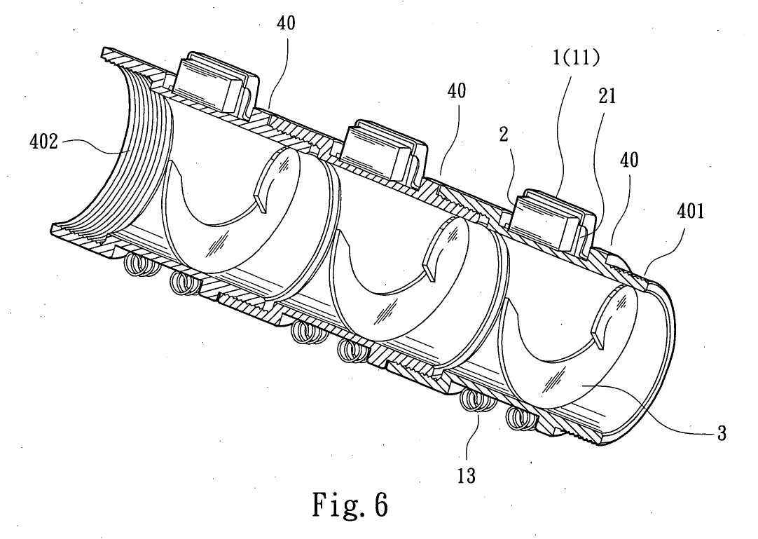

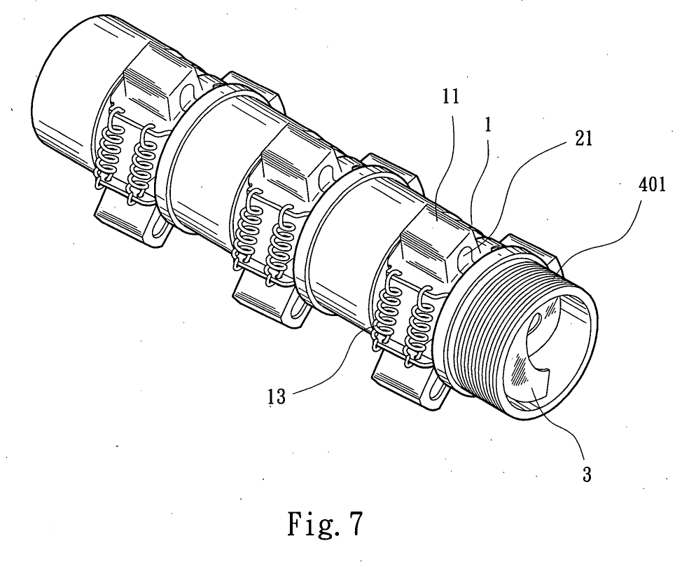

FIGS. 5 to 7 shows a third embodiment of the present invention, in which two ends of the fluid pipeline 40 are formed with corresponding inner thread and outer threads 402, 401. The inner and outer threads 402, 401 of a fluid pipeline can be screwed with the outer and inner threads of two adjacent pipelines 40 to elongate the fluid pipeline 40 to a preset length as actually necessary. The magnetic collars 1, the magnetic elements 2 and the spiral flow guiding plates 3 of the third embodiment are identical to the those of the first embodiment.

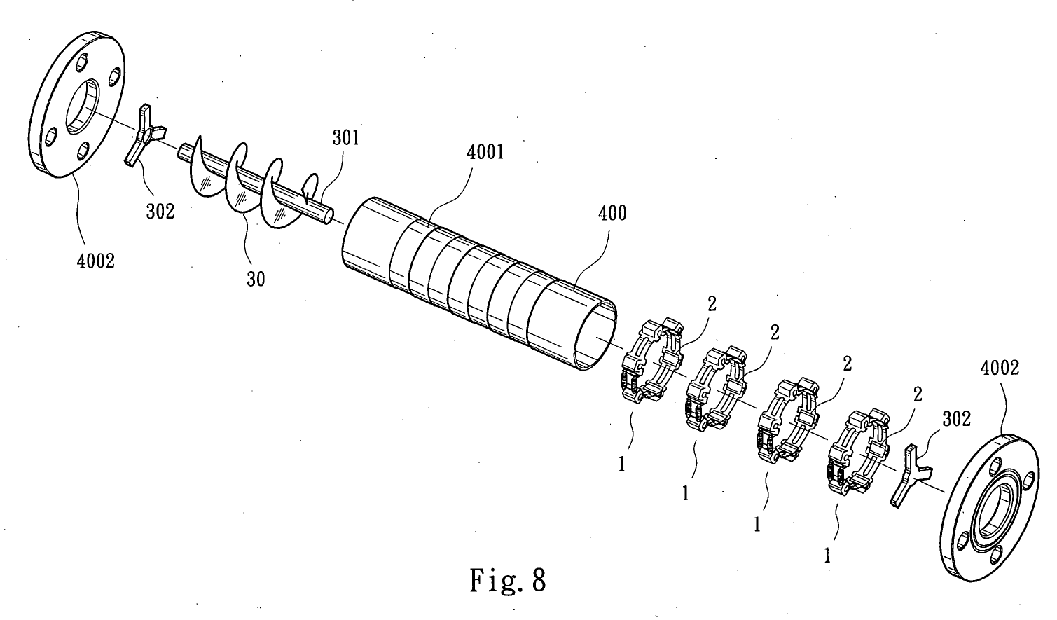

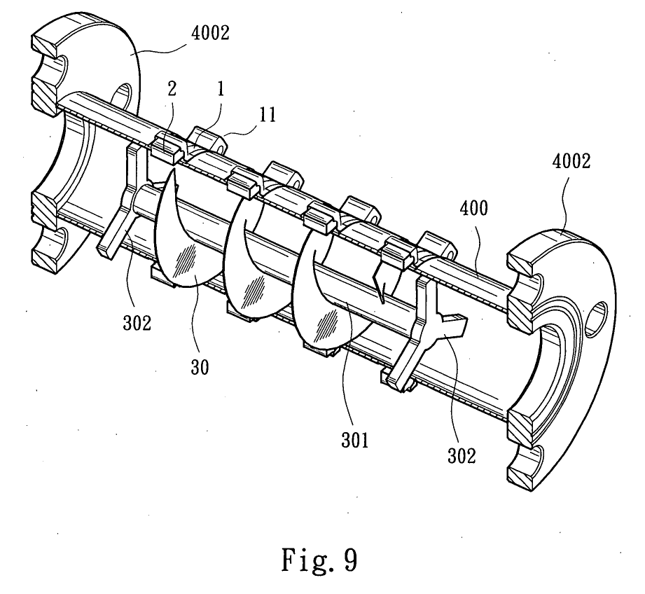

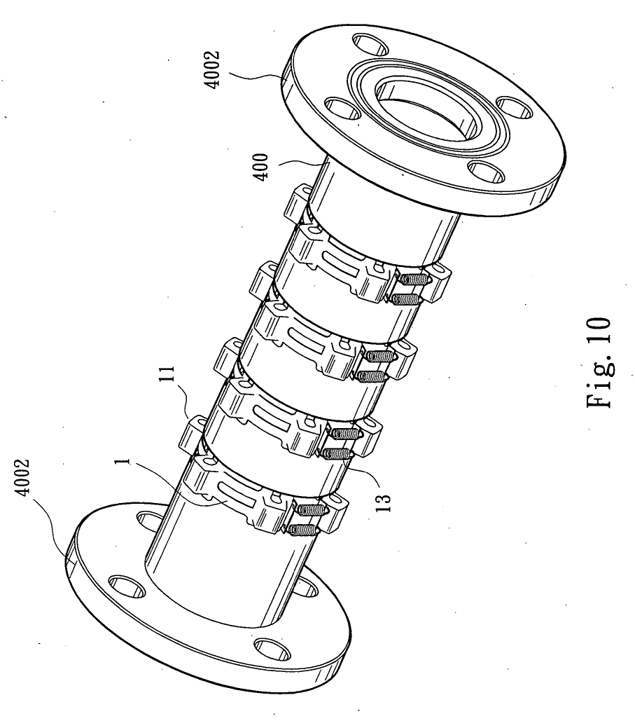

FIG. 8 is a perspective exploded view of a fourth embodiment of the present invention. Referring to FIG. 8 as well as FIGS. 9 and 10, the circumference of a middle section of the fluid pipeline 400 is formed with multiple annular grooves 4001 in each of which a magnetic collar 1 with a magnetic element 2 is inlaid to embrace the fluid pipeline 400. The spiral flow guiding plates 30 are fitted around a shaft rod 301. Two fixing brackets 302 are respectively disposed at two ends of the shaft rod 301 to retain the shaft rod 301 and the spiral flow guiding plates 30 in the fluid pipeline 400. Two ends of the fluid pipeline 400 are equipped with flanges 4002 for interconnecting different fluid pipelines 400.

According to the above arrangement, the fluid-magnetizing device of the present invention can be easily assembled to magnetize the fluid at high efficiency.

The above embodiments are only used to illustrate the present invention, not intended to limit the scope thereof. Many modifications of the above embodiments can be made without departing from the spirit of the present invention.

What is claimed is:

1. A fluid-magnetizing device comprising:
a magnetic collar which is an arced body, multiple outer casings being disposed on a circumference of the magnetic collar, the magnetic collar having two ends between which a locating member is connected for fitting and locating the magnetic collar around a fluid pipeline;
at least one magnetic elements accommodated in the outer casing of the magnetic collar; and
at least one spiral flow guiding plate disposed inside the fluid pipeline for guiding the fluid to spirally flow through the fluid pipeline, whereby the contact time between the fluid and the magnetic lines of the magnetic element is prolonged to more efficiently magnetize the fluid in the fluid pipeline.

2. The water-magnetizing device as claimed in claim 1, wherein the magnetic collar is made from magnetic conductive materials, the magnetic element being first fitted in an inner casing without magnetic conductivity and then the inner casing with the magnetic element being accommodated in the outer casing.

3. The water-magnetizing device as claimed in claim 1, wherein the locating member is a resilient member.

4. The water-magnetizing device as claimed in claim 2, wherein the locating member is a resilient member.

5. The water-magnetizing device as claimed in claim 3, wherein each of two ends of the magnetic collar is preformed with at least one hole, two ends of the resilient member being respectively formed with hook sections hooked in the holes of the two ends of the magnetic collar to resiliently connect the two ends of the magnetic collar.

6. The water-magnetizing device as claimed in claim 1, wherein the locating member is a non-resilient member, two ends of the locating member being respectively fixedly connected with the two ends of the magnetic collar.

7. The water-magnetizing device as claimed in claim 2, wherein the locating member is a non-resilient member, two ends of the locating member being respectively fixedly connected with the two ends of the magnetic collar.

8. The water-magnetizing device as claimed in claim 3, wherein a non-resilient locating member is further disposed between the two ends of the magnetic collar, two ends of the non-resilient locating member being respectively fixedly connected with the two ends of the magnetic collar.

9. The water-magnetizing device as claimed in claim 4, wherein a non-resilient locating member is further disposed between the two ends of the magnetic collar, two ends of the non-resilient locating member being respectively fixedly connected with the two ends of the magnetic collar.

10. The water-magnetizing device as claimed in claim 1, wherein two ends of the fluid pipeline are respectively formed with corresponding threaded sections, whereby the threaded sections of a fluid pipeline can be screwed with the threaded sections. of adjacent pipelines to elongate the fluid pipeline.

11. The water-magnetizing device as claimed in claim 2, wherein two ends of the fluid pipeline are respectively formed with corresponding threaded sections, whereby the threaded sections of a fluid pipeline can be screwed with the threaded sections of adjacent pipelines to elongate the fluid pipeline.

12. The water-magnetizing device as claimed in claim 3, wherein two ends of the fluid pipeline are respectively formed with corresponding threaded sections, whereby the threaded sections of a fluid pipeline can be screwed with the threaded sections of adjacent pipelines to elongate the fluid pipeline.

13. The water-magnetizing device as claimed in claim 4, wherein two ends of the fluid pipeline are respectively formed with corresponding threaded sections, whereby the threaded sections of a fluid pipeline can be screwed with the threaded sections of adjacent pipelines to elongate the fluid pipeline.

14. The water-magnetizing device as claimed in claim 6, wherein two ends of the fluid pipeline are respectively formed with corresponding threaded sections, whereby the threaded sections of a fluid pipeline can be.screwed with the threaded sections of adjacent pipelines to elongate the fluid pipeline.

15. The water-magnetizing device as claimed in claim 7, wherein two ends of the fluid pipeline are respectively formed with corresponding threaded sections, whereby the threaded sections of a fluid pipeline can be screwed with the threaded sections of adjacent pipelines to elongate the fluid pipeline.

16. The water-magnetizing device as claimed in claim 8, wherein two ends of the fluid pipeline are respectively formed with corresponding threaded sections, whereby the threaded sections of a fluid pipeline can be screwed with the threaded sections of adjacent pipelines to elongate the fluid pipeline.

17. The water-magnetizing device as claimed in claim 9, wherein two ends of the fluid pipeline are respectively formed with corresponding threaded sections, whereby the threaded sections of a fluid pipeline can be screwed with the threaded sections of adjacent pipelines to elongate the fluid pipeline.

18. The water-magnetizing device as claimed in claim 1, wherein the spiral flow guiding plates are fitted around a shaft rod, two fixing brackets being respectively disposed at two ends of the shaft rod to retain the shaft rod and the spiral flow guiding plates in the fluid pipeline.

19. The water-magnetizing device as claimed in claim 2, wherein the spiral flow guiding plates are fitted around a shaft rod, two fixing brackets being respectively disposed at two ends of the shaft rod to retain the shaft rod and the spiral flow guiding plates in the fluid pipeline.

20. The water-magnetizing device as claimed in claim 3, wherein the spiral flow guiding plates are fitted around a shaft rod, two fixing brackets being respectively disposed at two ends of the shaft rod to retain the shaft rod and the spiral flow guiding plates in the fluid pipeline.

21. The water-magnetizing device as claimed in claim 4, wherein the spiral flow guiding plates are fitted around a shaft rod, two fixing brackets being respectively disposed at two ends of the shaft rod to retain the shaft rod and the spiral flow guiding plates in the fluid pipeline.

22. The water-magnetizing device as claimed in claim 6, wherein the spiral flow guiding plates are fitted around a shaft rod, two fixing brackets being respectively disposed at two ends of the shaft rod to retain the shaft rod and the spiral flow guiding plates in the fluid pipeline.

23. The water-magnetizing device as claimed in claim 7, wherein the spiral flow guiding plates are fitted around a shaft rod, two fixing brackets being respectively disposed at two ends of the shaft rod to retain the shaft rod and the spiral flow guiding plates in the fluid pipeline.

24. The water-magnetizing device as claimed in claim 8, wherein the spiral flow guiding plates are fitted around a shaft rod, two fixing brackets being respectively disposed at two ends of the shaft rod to retain the shaft rod and the spiral flow guiding plates in the fluid pipeline.

25. The water-magnetizing device as claimed in claim 9, wherein the spiral flow guiding plates are fitted around a shaft rod, two fixing brackets being respectively disposed at two ends of the shaft rod to retain the shaft rod and the spiral flow guiding plates in the fluid pipeline.

26. The water-magnetizing device as claimed in claim 10, wherein the spiral flow guiding plates are fitted around a shaft rod, two fixing brackets being respectively disposed at two ends of the shaft rod to retain the shaft rod and the spiral flow guiding plates in the fluid pipeline.

27. The water-magnetizing device as claimed in claim 11, wherein the spiral flow guiding plates are fitted around a shaft rod, two fixing brackets being respectively disposed at two ends of the shaft rod to retain the shaft rod and the spiral flow guiding plates in the fluid pipeline.

28. The water-magnetizing device as claimed in claim 12, wherein the spiral flow guiding plates are fitted around a shaft rod, two fixing brackets being respectively disposed at two ends of the shaft rod to retain the shaft rod and the spiral flow guiding plates in the fluid pipeline.

29. The water-magnetizing device as claimed in claim 14, wherein the spiral flow guiding plates are fitted around a shaft rod, two fixing brackets being respectively disposed at two ends of the shaft rod to retain the shaft rod and the spiral flow guiding plates in the fluid pipeline.

30. The water-magnetizing device as claimed in claim 18, wherein the spiral flow guiding plates are fitted around a shaft rod, two fixing brackets being respectively disposed at two ends of the shaft rod to retain the shaft rod and the spiral flow guiding plates in the fluid pipeline.

31. The water-magnetizing device as claimed in claim 19, wherein the spiral flow guiding plates are fitted around a shaft rod, two fixing brackets being respectively disposed at two ends of the shaft rod to retain the shaft rod and the spiral flow guiding plates in the fluid pipeline.

32. The water-magnetizing device as claimed in claim 20, wherein the spiral flow guiding plates are fitted around a shaft rod, two fixing brackets being respectively disposed at two ends of the shaft rod to retain the shaft rod and the spiral flow guiding plates in the fluid pipeline.
